(19) United States
(12) Patent Application Publication
(10) Pub. No.: US 2011/0050986 A1
(43) Pub. Date: Mar. 3, 2011

(54) WINDOW FOR PORTABLE ELECTRONIC DEVICE

(75) Inventor: MO-JING WANG, Shenzhen (CN)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/768,690

(22) Filed: Apr. 27, 2010

(30) Foreign Application Priority Data
Aug. 25, 2009 (CN) 200910306022.X

(51) Int. Cl. H04N 5/222

(52) U.S. Cl. 348/371; 348/E05.022

(57) ABSTRACT

A portable electronic device includes a housing and a window. The housing includes a first through hole and a second through hole. The window is attached to the housing. The window includes a first transparent portion corresponding to the first through hole, a second transparent portion corresponding to the second through hole, and a wall surrounding the first through hole.

### BACKGROUND

1. Technical Field

The present disclosure relates to windows, particularly, to a window for use in a portable electronic device.

2. Description of Related Art

Digital cameras are widely used in portable electronic devices such as mobile phones, and personal digital assistants (PDAs). A flash is generally positioned adjacent to the camera for providing additional light to take a satisfactory exposure. To protect the camera and the flash from becoming scratched and dirty, a camera window and a flash window are used to cover the camera and the flash. Generally, the camera window and the flash window are separate units, which makes assembly more difficult.

Therefore, there is room for improvement within the art.

### BRIEF DESCRIPTION OF THE DRAWINGS

Many aspects of the window can be better understood with reference to the following drawings. The components in the drawings are not necessarily drawn to scale, the emphasis instead being placed upon clearly illustrating the principles of the window, in which:

FIG. 1 is an exploded, isometric view of a portable electronic device with a window, in accordance with an exemplary embodiment;

FIG. 2 is similar to FIG. 1, but shown from another aspect;

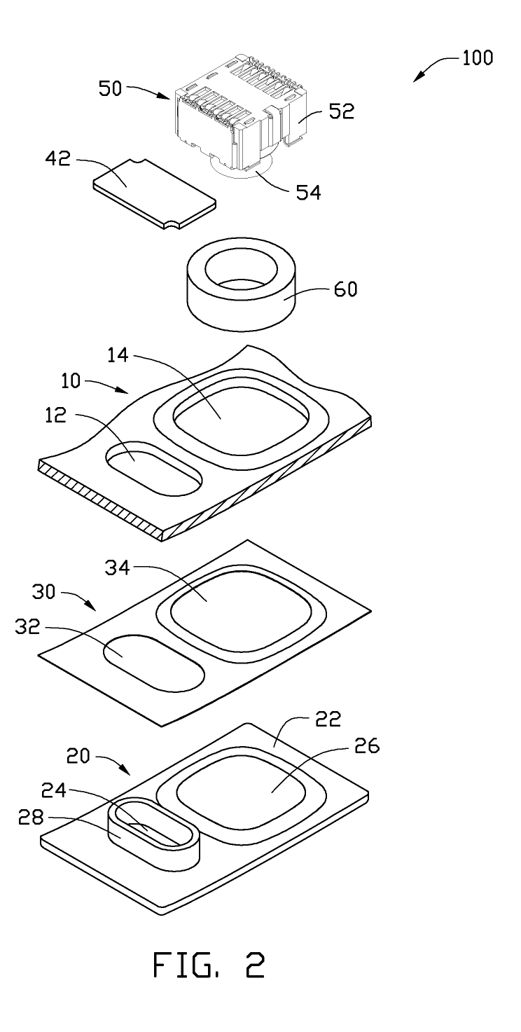

FIG. 3 is an assembled, isometric view of the portable electronic device shown in FIG. 1; and

FIG. 4 is a cross sectional view of the portable electronic device along line IV-IV of FIG. 3.

### DETAILED DESCRIPTION

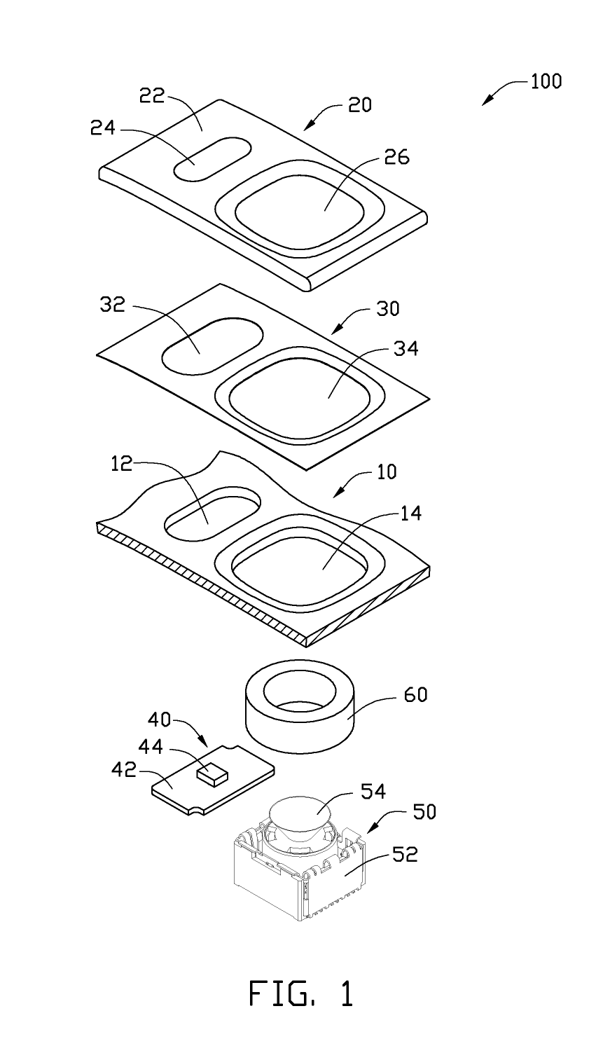

FIG. 1 shows an exemplary embodiment of a portable electronic device 100 with a window 20. The portable electronic device 100 further includes a housing 10, an adhesive layer 30, a flash module 40, a camera module 50, and a gasket 60.

The housing 10 defines a first through hole 12 and a second through hole 14. The first through hole 12 and the second through hole 14 allow the flash module 40 and the camera module 50 to be exposed from the housing 10 correspondingly.

The window 20 includes a main body 22 and an annular wall 28 projecting from the main body 22. The main body 22 includes a first transparent portion 24 and a second transparent portion 26 respectively corresponding to the first through hole 12 and the second through hole 14. The main body 22 is opaque except for the first transparent portion 24 and the second transparent portion 26. The first transparent portion 24 allows light out of the body 22 from the flash module 40. The second transparent portion 26 allows light into the camera module 50 for taking photos. The annular wall 28 surrounds the first transparent portion 24 for preventing light emitted from the flash module 40 from interfering with the camera module 50. The window 20 may be made of transparent material (e.g., polymethyl methacrylate) and opaquely colored except for the first transparent portion 24 and the second transparent portion 26, or made of plastic (e.g., acrylonitrile butadiene styrene and polycarbonate).

The flash module 40 includes a printed circuit board 42 and a light emitting portion 44 disposed on the printed circuit board 42. The camera module 50 includes a base 52 and a lens 54 fixed on the base 52. The gasket 60 is receivable in the second through hole 14 of the housing 10 and defines a receiving hole 62 for receiving the lens 54.

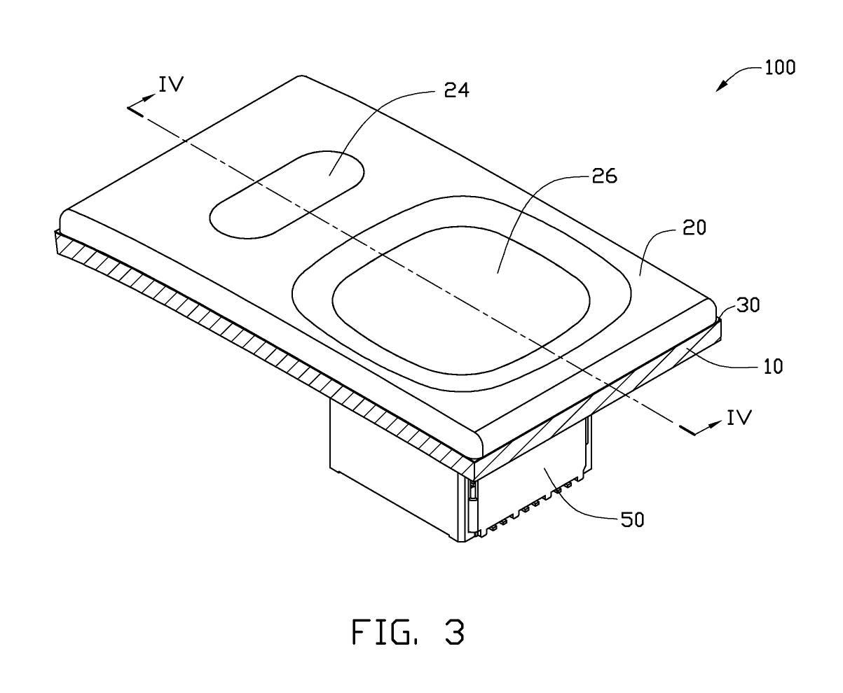

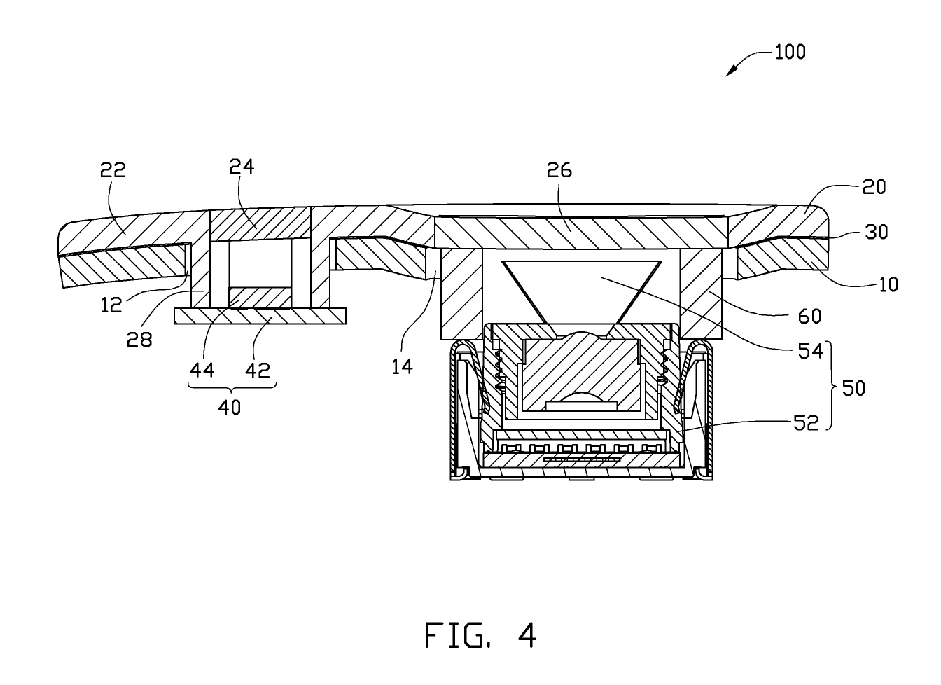

Referring to FIGS. 3-4, to assemble the portable electronic device 100, adhesive material (e.g., glue) is printed on the housing 10, and forms the adhesive layer 30 when dry. The window 20 is attached to the housing 10 before the adhesive material is dry, with the first transparent portion 24 aligned with the first through hole 12 and the second transparent portion 26 aligned with the second through hole 14. The annular wall 28 is received in the first through hole 12. The gasket 60 is received in the second through hole 14 of the housing 10 and resists the second transparent portion 26 of the cover 20. The lens 54 is received in the receiving hole 62. The gasket 60 is positioned between the base 52 and the second transparent portion 26, for preventing the lens 54 from touching the second transparent portion 26. Since the annular wall 28 surrounds the light emitting portion 44 and the gasket 60 surrounds the lens 54, light emitted from the light emitting portion 44 cannot directly shine into the lens 54.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A portable electronic device comprising:
a housing defining a first through hole and a second through hole; and
a window attached to the housing, the window including a first transparent portion corresponding to the first through hole, a second transparent portion corresponding to the second through hole, and a wall surrounding the first through hole.

2. The portable electronic device as claimed in claim 1, wherein the window is made of transparent material and is opaque except in the areas of the first transparent portion and the second transparent portion.

3. The portable electronic device as claimed in claim 1, wherein the window is made of plastic.

4. The portable electronic device as claimed in claim 3, wherein the window is made of acrylonitrile butadiene styrene and polycarbonate.

5. The portable electronic device as claimed in claim 3, further comprising an adhesive layer, wherein the adhesive layer is positioned between the housing and the window.

6. A portable electronic device comprising:
a housing defining a first through hole and a second through hole;
a window attached to the housing, the window including a first transparent portion corresponding to the first through hole, a second transparent portion corresponding to the second through hole, and a wall surrounding the first through hole;
a flash module including a light emitting portion, the light emitting portion being received in the wall; and
a camera module including a lens, the lens being received in the second through hole.

7. The portable electronic device as claimed in claim 6, further comprising a gasket, wherein the camera module further includes a base, the lens is received in the gasket, and the gasket is positioned between the base and the second transparent portion for preventing the lens from touching the second transparent portion.

8. The portable electronic device as claimed in claim 6, wherein the flash module further comprises a printed circuit board, and the light emitting portion is positioned on the printed circuit board.

9. The portable electronic device as claimed in claim 6, wherein the window is made of transparent material and is opaque except in the areas of the first transparent portion and the second transparent portion.

10. The portable electronic device as claimed in claim 6, wherein the window is made of plastic.

11. The portable electronic device as claimed in claim 10, wherein the window is made of acrylonitrile butadiene styrene and polycarbonate.

12. The portable electronic device as claimed in claim 6, further comprising an adhesive layer, wherein the adhesive layer is positioned between the housing and the window.

13. A portable electronic device comprising:
a light emitting element;
a lens;
a housing defining a first through hole and a second through hole, the lens being received in the second through hole; and
a window attached to the housing, the window including a first transparent portion windowing the first through hole, a second transparent portion windowing the second through hole, and a light shielding portion; the light shielding portion surrounding the light emitting element in the first through hole.

14. The portable electronic device as claimed in claim 13, further comprising a gasket, wherein the lens is received in the gasket, and the gasket prevents the lens from touching the second transparent portion.

15. The portable electronic device as claimed in claim 13, wherein the window is made of transparent material and is opaque except in the areas of the first transparent portion and the second transparent portion.

16. The portable electronic device as claimed in claim 13, wherein the window is made of plastic.

17. The portable electronic device as claimed in claim 16, wherein the window is made of acrylonitrile butadiene styrene and polycarbonate.

18. The portable electronic device as claimed in claim 13, further comprising an adhesive layer, wherein the adhesive layer is positioned between the housing and the window.
